(19) United States
(12) Patent Application Publication
(10) Pub. No.: US 2026/0099265 A1
(43) Pub. Date: Apr. 9, 2026

(54) MANAGING REFERENCE COUNT INCREMENTS

(71) Applicant: Dell Products L.P., Round Rock, TX (US)

(72) Inventors: Dror Zalstein, Givatayim (IL); Vladimir Shveidel, Pardes Hana-Karkur (IL); Jenny Derzhavetz, Raanana (IL)

(21) Appl. No.: 18/910,148

(22) Filed: Oct. 9, 2024

(51) Int. Cl. G06F 3/06

(52) U.S. Cl. CPC G06F 3/064; G06F 3/0604; G06F 3/0665; G06F 3/0679

(57) ABSTRACT

A technique of managing increfs (reference-count increments) of virtual-block entries of a metadata page includes recording a plurality of increfs in a plurality of record structures. Each of the plurality of record structures provided for storing one or more increfs of a single respective virtual-block entry of the metadata page, and at least one of the record structures allocated from a free-record bin in memory. The technique further includes, in response to an occurrence of a change condition, moving the plurality of increfs from the plurality of record structures to a set of range structures. Each of the set of range structures is provided for storing one or more increfs for a respective range of multiple contiguous virtual-block entries of the metadata page. The technique still further includes adding the plurality of record structures to the free-record bin.

### BACKGROUND

Data storage systems are arrangements of hardware and software in which storage processors are coupled to arrays of non-volatile storage devices, such as magnetic disk drives, electronic flash drives, and/or optical drives. The storage processors, also referred to herein as “nodes,” service storage requests arriving from host machines (“hosts”), which specify blocks, files, and/or other data elements to be written, read, created, deleted, and so forth. Software running on the nodes manages incoming storage requests and performs various data processing tasks to organize and secure the data elements on the non-volatile storage devices.

Normal operations of a data storage system can involve many changes in system metadata, such as reference counts, pointers, statistics, and the like. One approach to managing such changes entails operating two in-memory tablets, an active tablet and a frozen tablet. As actions arise that involve metadata changes, the storage system writes the changes to the active tablet. When the active tablet becomes full, the storage system freezes the active tablet, making it the new frozen tablet, and resets the frozen tablet, making it the new active tablet. The storage system then destages the metadata changes from the frozen tablet and writes the changes to metadata pages in persistent storage.

### SUMMARY

Certain embodiments are directed to a method of managing increfs (reference-count increments) of virtual-block entries of a metadata page. The method includes recording a plurality of increfs in a plurality of record structures, each of the plurality of record structures provided for storing one or more increfs of a single respective virtual-block entry of the metadata page, at least one of the record structures allocated from a free-record bin in memory. In response to an occurrence of a change condition, the method further includes moving the plurality of increfs from the plurality of record structures to a set of range structures. Each of the set of range structures is provided for storing one or more increfs for a respective range of multiple contiguous virtual-block entries of the metadata page. The method further includes adding the plurality of record structures to the free-record bin.

Other embodiments are directed to a computerized apparatus constructed and arranged to perform a method of managing increfs, such as the method described above. Still other embodiments are directed to a computer program product. The computer program product stores instructions which, when executed on control circuitry of a computerized apparatus, cause the computerized apparatus to perform a method of managing increfs, such as the method described above.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is a block diagram of an example environment in which embodiments of the improved technique can be practiced.

FIG. 2 is a block diagram of an example data path that may be used in the environment of FIG. 1 according to one or more embodiments.

FIG. 3 is a block diagram of an example bucket within an active tablet of FIG. 1, which includes a delta list of record structures for a metadata page, according to one or more embodiments.

FIG. 4 is a block diagram of the example bucket of FIG. 3, which includes both a delta list of record structures and a range list of range structures that store increfs for a metadata page, according to one or more embodiments.

FIG. 5 is a block diagram of the example bucket of FIG. 3, which includes a delta list of record structures for a metadata page and a reference to an array structure that stores increfs for the metadata page according to one or more embodiments.

FIG. 6 is a flowchart showing an example method of managing increfs according to one or more embodiments.

FIG. 7 is a flowchart showing an example method of managing increfs of virtual-block entries of a metadata page, according to one or more embodiments.

### DETAILED DESCRIPTION

As stated above, tablet switches occur when the active tablet becomes full. In practice, a pool of memory may be allocated for use by the active tablet, and the allocated memory fills as new metadata changes are written to the active tablet.

One consequence of the above-described arrangement is that the active tablet can become full in an imbalanced manner. For instance, certain metadata changes, known as “increfs” (reference-count increments) can occur in large numbers during short intervals of time, in a phenomenon known as “jet stress.” Consider as an example a storage system that backs an email server which receives 1,000 copies of a particular file. Rather than storing 1,000 unique copies of the file's data, the storage system may instead store a single copy, which is shared among 1,000 logical instances of the file. Behind the scenes, the storage system may apply 1,000 increfs to each data block of the file, i.e., one incref per data block for each logical instance of the file.

The above-described jet-stress scenario can quickly fill up the allocated memory pool with increfs, triggering a tablet switch earlier than would otherwise occur. Unfortunately, the early tablet switch can have detrimental effects, as it means that other metadata changes (non-incref changes) have less time to accumulate in the active tablet. Aggregation of such metadata changes is thus impaired and resources are wasted. Incref aggregation can itself be impaired, due to the way that increfs are stored. What is needed, therefore, is a more balanced and memory-conserving way of handling increfs.

The above need is addressed at least in part by an improved technique of managing increfs. The technique includes initially recording increfs directed to virtual block entries of a metadata page in respective record structures. The virtual-block entries are associated with respective data blocks and hold reference counts for those data blocks. At least one of the record structures is allocated from a free-record bin. The technique further includes, in response to a change condition, moving the increfs from the record structures to a set of range structures, where a range structure covers a contiguous range of multiple virtual-block entries of the metadata page, and sending the record structures to the free-record bin.

Advantageously, the movement of increfs from record structures to range structures promotes efficiency. Further, the free-record bin conserves memory by ensuring that record structures can be reused. This aspect is particularly beneficial in storage systems that do not support freeing of memory allocated to tablets, as may be the case with certain embodiments.

Embodiments of the improved technique will now be described. One should appreciate that such embodiments are provided by way of example to illustrate certain features and principles but are not intended to be limiting.

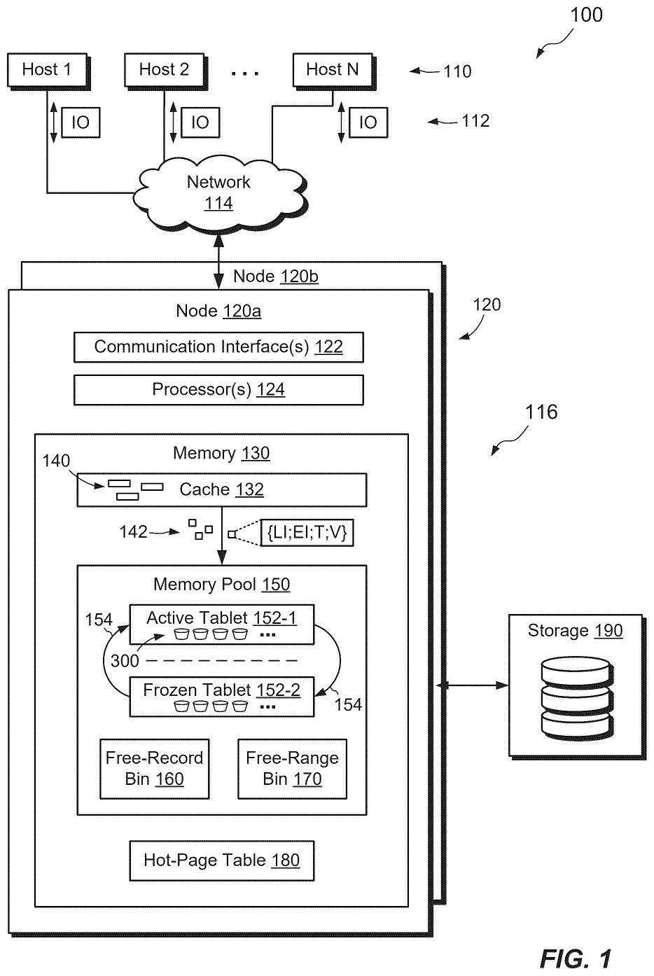

FIG. 1 shows an example environment 100 in which embodiments of the improved technique can be practiced. Here, multiple hosts 110 are configured to access a data storage system 116 over a network 114. The data storage system 116 includes one or more nodes 120 (e.g., node 120a and node 120b), and storage 190, such as magnetic disk drives, electronic flash drives, and/or the like. Nodes 120 may be provided as circuit board assemblies or blades, which plug into a chassis (not shown) that encloses and cools the nodes. The chassis has a backplane or midplane for interconnecting the nodes 120, and additional connections may be made among nodes 120 using cables. In some examples, the nodes 120 are part of a storage cluster, such as one which contains any number of storage appliances, where each appliance includes a pair of nodes 120 connected to shared storage. In some arrangements, a host application runs directly on the nodes 120, such that separate host machines 110 need not be present. No particular hardware configuration is required, however, as any number of nodes 120 may be provided, including a single node, in any arrangement, and the node or nodes 120 can be any type or types of computing device capable of running software and processing host I/O's.

The network 114 may be any type of network or combination of networks, such as a storage area network (SAN), a local area network (LAN), a wide area network (WAN), the Internet, and/or some other type of network or combination of networks, for example. In cases where hosts 110 are provided, such hosts 110 may connect to the node 120 using various technologies, such as Fibre Channel, iSCSI (Internet small computer system interface), NVMeOF (Nonvolatile Memory Express (NVMe) over Fabrics), NFS (network file system), and CIFS (common Internet file system), for example. As is known, Fibre Channel, iSCSI, and NVMeOF are block-based protocols, whereas NFS and CIFS are file-based protocols. The node 120 is configured to receive I/O requests 112 according to block-based and/or file-based protocols and to respond to such I/O requests 112 by reading or writing the storage 180.

The depiction of node 120a is intended to be representative of all nodes 120. As shown, node 120a includes one or more communication interfaces 122, a set of processors 124, and memory 130. The communication interfaces 122 include, for example, SCSI target adapters and/or network interface adapters for converting electronic and/or optical signals received over the network 114 to electronic form for use by the node 120a. The set of processors 124 includes one or more processing chips and/or assemblies, such as numerous multi-core CPUs (central processing units). The memory 130 includes both volatile memory, e.g., RAM (Random Access Memory), and non-volatile memory, such as one or more ROMs (Read-Only Memories), disk drives, solid state drives, and the like. The set of processors 124 and the memory 130 together form control circuitry, which is constructed and arranged to carry out various methods and functions as described herein. Also, the memory 130 includes a variety of software constructs realized in the form of executable instructions. When the executable instructions are run by the set of processors 124, the set of processors 124 is made to carry out the operations of the software constructs. Although certain software constructs are specifically shown and described, it is understood that the memory 130 typically includes many other software components, which are not shown, such as an operating system, various applications, processes, and daemons.

As further shown in FIG. 1, the memory 130 “includes,” i.e., realizes by execution of software instructions acting upon data, a cache 132, a memory pool 150, and a hot-page table 180. The cache 132 is configured to store metadata pages 140, such as pages that store reference counts. In some examples, metadata pages 140 may be read into cache 132 from storage 190, updated in cache 132, and then written back to storage 190. The memory pool 150 is an allocated region of memory 130 dedicated to aggregating metadata changes. For example, the memory pool 150 has a specified size that is shared equally between active tablet 152-1 and the frozen tablet 152-2. The hot-page table 180 is a list of metadata pages 140 that receive the most increfs and provides certain optimizations.

The active tablet 152-1 is configured to receive new metadata changes 142 and to organize such changes 142 in individual buckets 300. In some examples, the buckets 300 correspond to respective ranges of hash values that are calculated based on identifiers of the metadata pages 140. Such identifiers may be referred to herein as “logical indices,” or “LIs.” For example, one bucket of the active tablet 152-1 corresponds to a first range of hashed LIs and another bucket of the active tablet 152-1 corresponds to a second, distinct range of hashed LIs. The hashing scheme aims to uniformly distribute LIs across different buckets, thus avoiding hot spots. Because each bucket is provided for a range of hash values, each bucket is configured to track metadata changes for multiple LIs. As metadata changes 142 arise, node 120 identifies the LI associated with the change, hashes the LI, and places the metadata change 142 in the bucket 300 assigned to the hash range that includes the hashed LI.

In an example, metadata changes 142 are provided in a compact format, such as a tuple having four elements: LI; EI; T; and V. “LI” is the logical index mentioned above, which may correspond to an LBA (logical block address) or other unique identifier of the metadata page 140 being updated. “EI” is an entry index. A metadata page 140 typically includes multiple entries, which may be arranged in an array or similar structure, with each index (entry) identified by an EI. As a specific example, a VLB (virtual large block) metadata page may include over a hundred entries, referred to herein as “virtual-block entries,” with each entry representing a respective virtual block, which points to a respective physical block in storage 190. Virtual-block entries have respective reference counts, which may be managed according to techniques described herein. “T” indicates a type of metadata change, such as an incref, a pointer change, or some other type of change, and “V” indicates a value, such as a new value of the entry or a change relative to a previous value. In the case of increfs, T may identify an incref as the type of change and V may provide a relative value, such as +1 for a reference-count increment of 1.

The frozen tablet 152-2 is a frozen version of a previously active tablet 152-1. For example, once an active tablet become full (e.g., consume its allocated share of the memory pool 150), node 120 freezes the active tablet, so that no further metadata changes 142 are accepted. Around the same time, node 120 clears and reactivates the frozen tablet, such that it becomes the new active tablet, which is able to receive new metadata changes 142. A tablet switch 154 indicates a change between active and frozen tablets. The frozen tablet 152-2 may be destaged to storage 190, e.g., by reading metadata pages 140 referenced by the frozen tablet, updating the pages to include all of the indicated changes, and then writing the updated pages 140 back to storage 190.

In some examples, the memory pool 150 further includes a free-record bin 160 and a free-range bin 170. The free-record bin 160 provides a list of incref record structures that were previously allocated from the memory pool 150 but are no longer being used. Similarly, the free-range bin 170 provides a list of incref range structures that were previously allocated from the memory pool 150 but are no longer being used. As will be described, record structures and range structures are provided for managing increfs efficiently. The free lists 160 and 170 allow record structures and range structures to be reused within tablet cycles (between tablet switches), helping to conserve memory.

For example, some implementations of the memory pool 150 do not support releasing or freeing of memory space. Thus, memory space allocated from the pool 150 for storing record structures and range structures cannot be returned to the pool 150 for general use. This inability to free memory space can be a particular obstacle in cases where fullness of the memory pool 150 drives tablet switches 154, as consumption of memory for record structures and range structures can trigger premature tablet switches 154. The free-record bin 160 and free-range bin 170 help to address this obstacle by allowing record structures and range structures to be reused as needed.

In example operation, hosts 110 issue I/O requests 112 to the data storage system 116. A node 120 receives the I/O requests 112 at the communication interfaces 122 and initiates further processing. Such processing involves forming metadata changes 142 to accommodate storage activities, such as writes, deletes, deduplication, and other actions. The node 120 forms the metadata changes 142 using the compact format, {LI; EI; T; and V}. For each change 142, the node 120 hashes the specified LI and uses the hash value to identify a bucket 300 in the active tablet 152-1 in which to store the metadata change 142. The identified bucket may include metadata changes 142 for multiple LIs, which may be arranged in nodes of a tree, for example. The metadata change 142 is entered into the tree under the node for the specified LI.

The node for the specified LI points to a record list, e.g., a linked-list, which provides a time-ordered list of record structures that record metadata changes to that LI. The record structures may store increfs as well as non-incref metadata changes. Initially, the node 120 may attempt to update increfs in place. For example, if two increfs arise in sequence and are directed to the same LI and EI (virtual-block entry), node 120 may overwrite the record structure for the first incref (+1) with the sum of the first incref and the second incref (+2). This approach is practical as long as the record list is short.

Beyond a certain length, it is no longer computationally efficient to overwrite in place, and the node 120 simply appends new record structures for newly arriving increfs to the record list. New record structures for increfs may be obtained from the free-record bin 160, assuming free record structures are available. Otherwise, new record structures may be allocated from the memory pool 150.

Eventually, as additional metadata changes directed to the same LI arise, the record list may become long and significant memory may be consumed by the associated record structures. At this point, the node 120 may switch from using record structures for tracking increfs to using range structures. Range structures are small arrays having a few elements, such as 4, 8, or 16 elements, which correspond to contiguous ranges of virtual-block entries (EIs) for a particular LI. For example, a first range structure might correspond to virtual-block entries 0-7 of a LI, a second range structure might correspond to virtual-block entries 8-15 of the same LI, and so on. The node 120 moves any increfs stored in record structures to corresponding range structures. For example, any increfs directed to virtual-block entries 0 through 7 are moved to the first range structure, any increfs directed to virtual-block entries 8 through 15 are moved to the second range structure, and so on. A range list may be provided for tracking range structures associated with the LI. Once increfs have been moved from record structures to range structures, the record structures may be freed, i.e., sent to the free-record bin 160. Also, newly required range structures may be allocated from the free-range bin 170, if free range structures are available. Otherwise, they may be allocated from the memory pool 150.

Preferably, each range structure provides a single integer for each of the virtual-block entries that it tracks. For example, a single range structure provided for eight virtual-block entries has eight integer values. Increfs stored in range structures are updated in place. Preferably, each unique range of virtual-block entries has only one associated range structure, regardless of the numbers of increfs. Range structures may be provided in a sparse manner, e.g., only for ranges of virtual-block entries in which increfs are recorded. Although some of the virtual-block entries tracked by a range structure may have no associated increfs, the use of range structures is still more memory-efficient than the use of many appended record structures.

If still more increfs arise, the range structures themselves may become inefficient to operate. For example, the range list for a particular LI may become unmanageably long. When this occurs, node 120 may respond by switching from range structures to a full array structure. The array structure includes an integer value for each of the virtual-block entries in the metadata page, e.g., over 100 integer values. Incref totals are moved from range structures to the array structure for the respective virtual-block entries, and the range structures are freed, e.g., sent to the free-range bin 170. In an example, the array structure remains in place until the next tablet switch 154.

When the next tablet switch 154 occurs, node 120 may identify the LIs having the greatest numbers of increfs, such as the top 1,000 LIs or top 10,000 LIs, for example. These “hottest LIs” may then be applied by starting initially upon the next tablet cycle with the same type of structure that was used at the end of the previous one, i.e., when the tablet switch 154 occurred, thus avoiding the full progression from record structures to range structures to an array structure. For example, any of the hottest LIs that used range structures at the time of the tablet switch 154 may start out on the next cycle using range structures instead of record structures. Likewise, any of the hottest LIs that used array structures at the time of the tablet switch 154 may start out on the next cycle using array structures. In an example, the hot-page table 180 provides a list of the hottest LIs and the associated structures (range or array) that were used upon the tablet switch 154. Upon a first incref arising for a particular LI upon the next tablet cycle, the node 120 checks the hot-page table 180 to determine whether the particular LI is listed and, if so, starts out using the indicated structure (range or array). In an example, the hot-page table 180 is arranged as a hash table based on hash of LI. The hottest LIs may be easily identified upon tablet switches 154, as node 120 already examines tablets for metadata changes at this time.

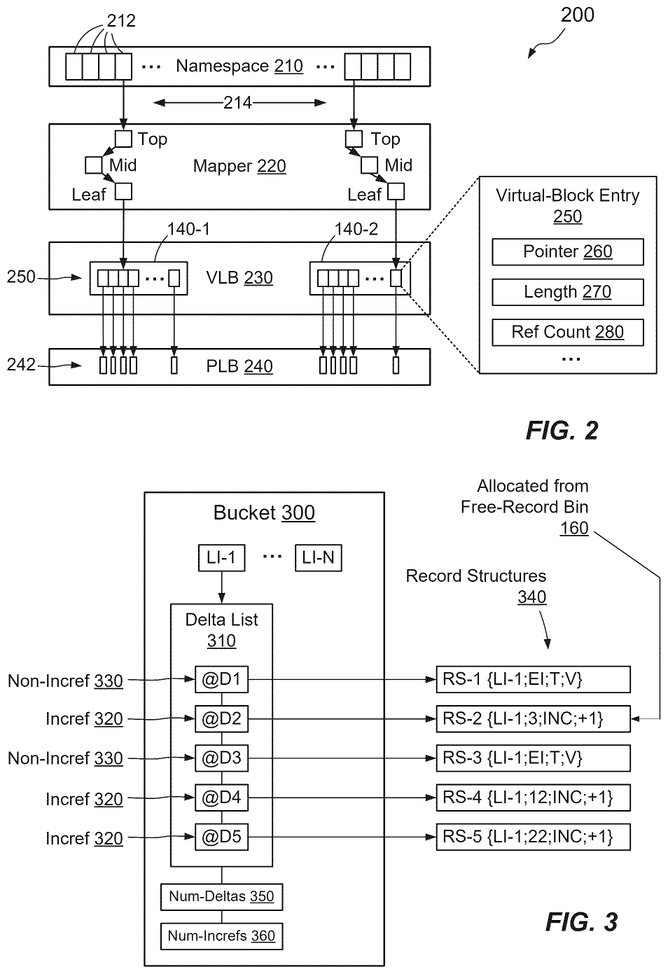

FIG. 2 shows an example data path 200 for mapping data in the storage system 116 and provides an example context in which increfs may arise according to one or more embodiments. The data path 200 provides a way of locating physical data blocks in storage 190 based on logical addresses. One should appreciate that data paths may be implemented in a variety of ways and that the example shown is intended to be illustrative rather than limiting.

As shown in FIG. 2, the data path 200 includes a namespace 210, a mapper 220, a VLB (virtual large block) layer 230, and a PLB (physical large block) layer 240. The namespace 210 is configured to arrange logical data blocks 212 in a large logical address space 214. Data objects such as LUNs (Logical UNits), files systems, and virtual-machine disks may be provided within respective ranges of the namespace 220. No actual user data is stored in the namespace 210, however. Rather, the namespace 220 is a logical structure that points to rather than stores user data.

The mapper 220 includes trees of mapping pointers that map logical blocks 212 in the namespace 210 to respective virtual blocks in the VLB layer 230. For example, the mapper 220 includes three layers of mapping pointers, shown here as tops, mids, and leaves. The role of the mapper 220 is to provide a pointer path from each allocated logical block 212 to a respective virtual block. To this end, the mapper 220 may include arrays of mapping pointers, which are stored within metadata pages 140.

In the VLB layer 230, virtual blocks are represented by respective virtual-block entries 250 (referred to above). The virtual-block entries 250 also reside within metadata pages 140, with two metadata pages 140-1 and 140-2 specifically shown. For example, over 100 virtual-block entries 250 may be stored within each of the metadata pages 140-1 and 140-2. The metadata pages 140-1 and 140-2 have respective LIs, and each virtual-block entry 250 within these metadata pages has a respective EI, which identifies its ordinal location.

An example virtual-block entry 250 is shown to the right of FIG. 2. Here, the virtual-block entry 250 has multiple fields, such as a pointer 260, a length 270, and a reference count 280. Typically, the pointer 260 points to a physical data block 242 in the PLB layer 240, thus associating the virtual-block entry 250 with a physical block 242 and completing a path between a logical block 212 and a physical block 242. The physical block 242 is typically compressed, and the length 270 indicates a size of the compressed block.

The reference count 280 maintains a count of elements that point to the virtual-block entry 250, such as leaf pointers in the mapper 220 and in some cases other virtual-block entries 250. Although FIG. 2 shows only a single leaf pointer pointing to each virtual-block entry 250, deduplication activities conducted by the storage system 116 can cause multiple leaf pointers in the mapper 220 to point to a single virtual-block entry 250. In addition, certain types of data consolidation can cause certain virtual-block entries 250 to point to other virtual-block entries 250. In an example, the increfs as described herein refer to increments to reference counts 280. This is just an example, though, as other types of metadata pages 140 also have reference counts and similar a approach may be used for those.

FIG. 3 shows an example bucket 300, which provides an example of how increfs may initially be managed by node 120 according to one or more embodiments. Bucket 300 may be representative of the buckets 300 found in the active tablet 152-1. As shown, bucket 300 organizes metadata changes for multiple LIs, e.g., LI-1 through LI-N, where LIs may be represented as nodes of a tree (not shown). Focusing now on LI-1, it is seen that LI-1 references a delta list 310, which may be implemented as a time-ordered linked list of metadata changes 142, for example. Elements of the delta list 310 (e.g., @D1 through @D5) point to respective record structures 340 (e.g., RS-1 through RS-5), where each record structure 340 stores a respective metadata change. The metadata changes on the delta list 310 may include incref deltas 320 as well as non-incref deltas 330.

In the example shown, the record structures 340 store metadata changes using the above-described 4-part tuple {LI; EI; T; and V}. In other examples, certain parts of the tuple may be implied (such as LI) and thus omitted. Other parts may be combined.

In an example, the record structures 340 are data structures having particular sizes and formats. In some examples, record structures 340 that store increfs have fixed size, whereas record structures for storing non-incref deltas 330 have variable size. Given their fixed size and format, incref record structures 340 may be reusable. For example, any of the record structures 340 used for increfs may be allocated from the free-record bin 160, i.e., to reuse an incref record structure 340 that was previously used and then freed during the same tablet cycle.

As further shown in FIG. 3, certain statistics may be stored in connection with LI-1 (and with LIs generally), such as the number of deltas 350 in the delta list 310 (5 in the illustrated example) and the number of increfs 360 received for LI-1 (3 in the illustrated example). Both numbers 350 and 360 are relative to the current tablet cycle, as delta lists 310 are reset at the end of each cycle.

In operation and at the beginning of a tablet cycle, increfs directed to the same EI (for a given LI) may be updated in place. Note, for example, that RS-2 records an incref for EI-3, with a value +1, indicating that the associated reference count 280 is being increased by 1. If a new incref directed to EI-3 arises, the value of +1 in RS-2 may be increased to +2. Given the commutative property of addition, it is not necessary to maintain the individual identities of increfs, and their time ordering need not be preserved.

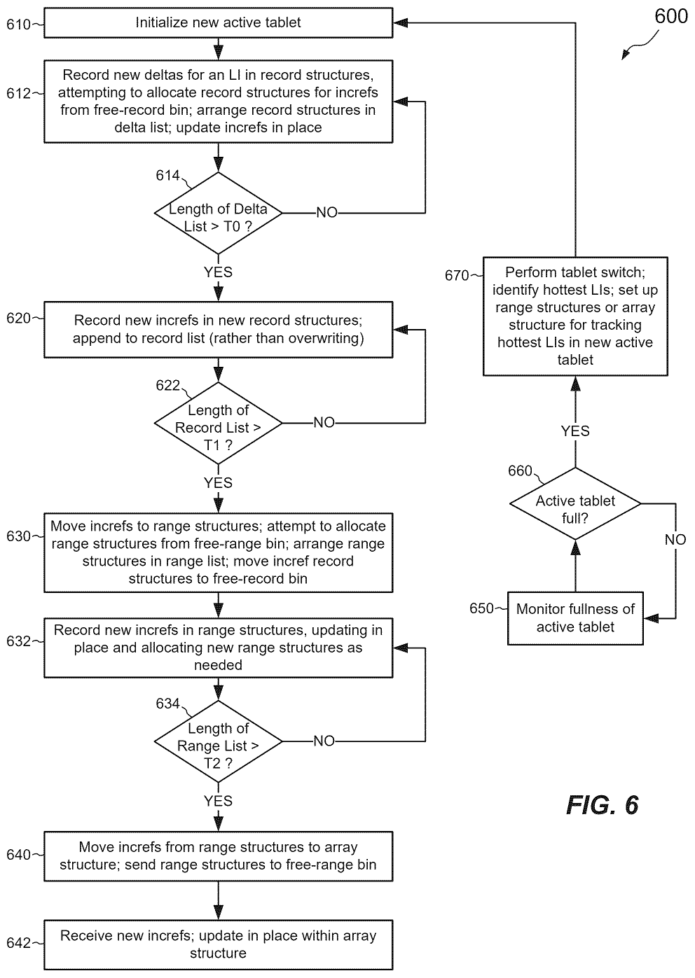

To support updates of increfs in place, the node 120 traverses at least a portion of the delta list 310, e.g., in an attempt to match the EI of a new incref with the EI of an incref already present in the delta list 310. Such matching attempts consume valuable computing resources, however. Above a threshold number of deltas (T0 in FIG. 6), which may be determined by checking the number 350 of deltas, node 120 switches from performing updates in place to appending new increfs to the tail of the delta list 310. Appending increfs, rather than updating them in place, reduces processing requirements, but it also increases memory usage, as a new record structure 340 is used for each new incref.

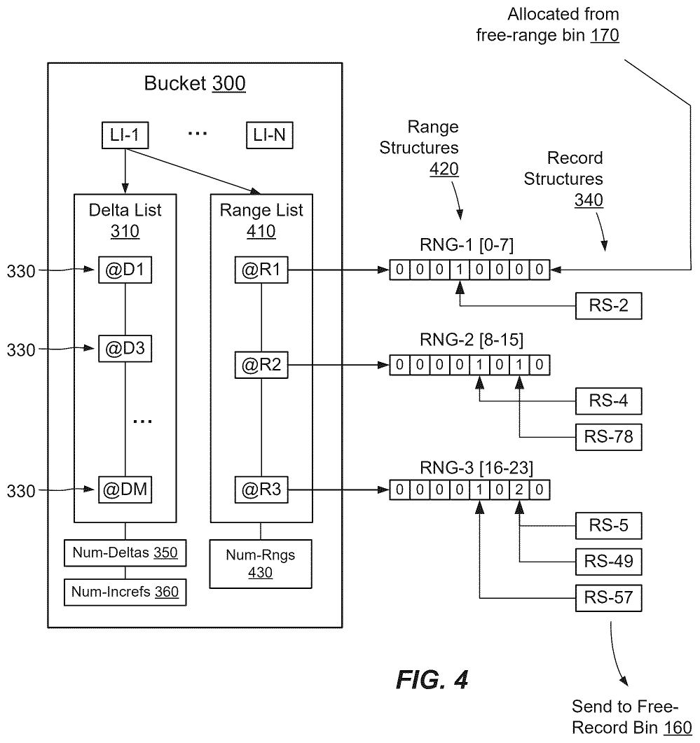

FIG. 4 shows the same bucket 300 and associated structures at a later point in time during the same tablet cycle. Here, additional deltas have arrived such that the number 350 of deltas has reached (e.g., equaled or exceeded) a first threshold (T1). At this point, the node 120 changes from recording increfs 320 in record structures 340 to recording increfs 320 in range structures 420. As shown, range structures 420 are small arrays of a few elements (8 in the depicted example), which track incref totals for a range of EIs (virtual-block entries). For example, a first range structure RNG-1 tracks EIs 0 through 7, a second range structure RNG-2 tracks EIs 8 through 15, and a third range structure RNG-3 tracks EIs 16 through 23. Additional range structures 420 may be provided every eight EIs, as needed. In an example, range structures 420 have fixed sizes and formats, making them readily reusable. When providing the range structures 420 shown in FIG. 4, node 120 attempts to obtain the range structures 420 from the free-range bin 170.

Changing from record structures 340 to range structures 420 involves moving the increfs 320 accumulated in the record structures 340 to corresponding range structures 420 and freeing the record structures 340, e.g., sending them to the free-record bin 160. Such changing further involves removing increfs 320 from the delta list 310, such that only non-incref deltas 330 remain.

As shown to the right of FIG. 4, the incref for EI-3 in RS-2 (FIG. 3) is moved to the third position of RNG-1 (counting starts at 0). Also, the incref for EI-12 in RS-4 is moved to the fourth position of RNG-2, and the incref for EI-22 in RS-5 is moved to the sixth position of RNG-3. It is assumed that additional increfs 320 that arrived after the time shown in FIG. 3 were stored in record structures RS-49, RS-57, and RS-78. Such increfs further populate the range structures 420. In an example, increfs stored in the range structures 420 are updated in place. Thus, each range structure 420 stores 8 integer values.

In an example, the bucket 300 includes a range list 410, which provides a list of range structures 420 that track increfs for LI-1. The bucket 300 may further maintain a statistic that provides the number 430 of range structures 420 on the range list 410.

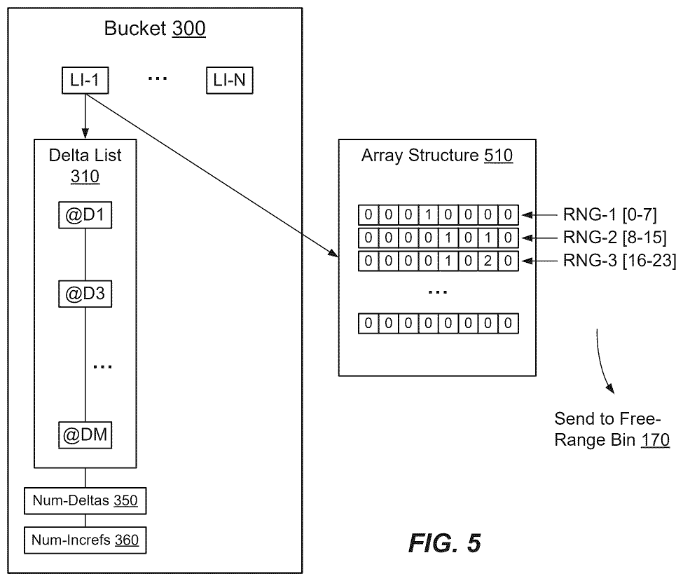

FIG. 5 shows a further level of incref consolidation. Here, the range structures 420 of FIG. 4 have been consolidated into a single array structure 510, which includes an integer value for all EIs (virtual-block entries) in the metadata page identified by LI-1.

For example, the increfs tracked by RNG-1, RNG-2, and RNG-3 have been moved into respective EI ranges of the array structure 510, and the emptied range structures 420 have been sent to the free-range bin 170. The range list 410 has been removed, and the array structure 510 has been associated with LI-1. In an example, the switch from range structures 420 to the array structure 510 is based on the number 430 of ranges reaching a second threshold value (T2). For example, the threshold value T2 represents a length of the range list 410 at which traversing the range list becomes computationally expensive.

Going forward, increfs are updated in place within the array structure 510 until the end of the current tablet cycle. The array structure 510 consumes substantial memory, which is typically more than record structures 340 or range structures 420 would require. But the necessity of using the array structure 510 has been justified by the progression from record structures 340 to range structures 420 and then to the array structure 510.

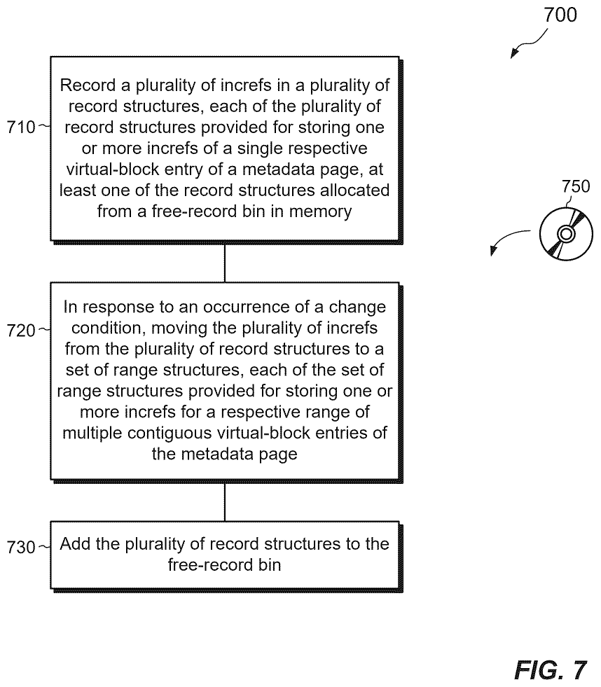

FIGS. 6 and 7 show example methods 600 and 700 of managing increfs according to one or more embodiments. The methods 600 and 700 may be carried out in connection with the environment 100 and are typically performed, for example, by the software constructs described in connection with FIG. 1, which reside in the memory 130 of a node 120 and are run by the set of processors 124. The various acts of methods 600 and 700 may be ordered in any suitable way. Accordingly, embodiments may be constructed in which acts are performed in orders different from those illustrated, which may include performing some acts simultaneously.

At 610, method 600 begins by initializing a new active tablet 152-1. For example, a tablet switch 154 has just occurred and a new active tablet is provided. In an example, the new active tablet 152-1 is initially empty.

At 612, new metadata changes 142 (deltas) are recorded for LIs in record structures 340. For example, new deltas arise for LI-1, as shown in FIG. 3. The deltas may include incref deltas 320 and non-incref deltas 330. For incref deltas 330, node 120 first attempts to obtain record structures 340 from the free-record bin 160. If the free-record bin 160 is empty, node 120 may instead allocate record structures 340 from the memory pool 150. Node 120 arranges record structures 340 for storing deltas for LI-1 in a delta list 310, e.g., a time-ordered linked list associated with LI-1. As long as the delta list 310 is short, e.g., shorter than a threshold length T0, node 120 performs updates-in-place of increfs directed to the same virtual-block entries 250. For example, if two incref deltas arise that specify LI-1 and EI-1, the second incref delta merely results in node 120 changing the value of the record structure for the first incref delta from +1 to +2.

At 614, node 120 checks whether the length of delta list 310 has reached T0 (e.g., equals or exceeds T0), e.g., by checking the number 350 of deltas. If the length has not reached T0, incref deltas 330 continue to be recorded as in 612. Otherwise, operation proceeds to 620, whereupon updates-in-place for increfs cease and new incref deltas 330 are recorded by appending new record structures 340 onto the delta list 310.

Operation proceeds in this manner until the length of the delta list 310 reaches a first threshold T1 (622), where T1 is greater than T0. Once the first threshold has been reached, operation proceeds to 630, whereupon incref deltas are moved from record structures 340 to range structures 420. Node 120 first attempts to allocate range structures 420 from the free-range bin 170, and then from the memory pool 150 if the free-range bin 170 is empty. Node 120 arranges the range structures 420 in a range list 410 associated with LI-1 (see also FIG. 4). The previously used incref record structures 340 are moved to the free-record bin 160, where they are available for allocation for tracking increfs directed to other LIs among the active tablet 152-1. For example, node 120 may handle increfs in a similar manner for all LIs arranged in the active tablet 152-1, with the free-record bin 160 and the free-range bin 170 being shared resources.

At 632, node 120 produces new increfs directed to LI-1 and records them in range structures 420, updating increfs in place to accommodate multiple increfs directed to the same EIs. Such new incref deltas may also be referred to herein as a “second plurality of increfs.” New range structures 420 are allocated (or obtained from the free-range bin 170) as needed, as new increfs arise that are directed to ranges for which no range structures 420 have yet been provided.

At 634, node 120 monitors the length of the range list 410 (e.g., the Num-Rngs statistic 430). If the number of ranges reaches a second threshold T2, operation proceeds to 640. Otherwise, increfs continue to be recorded as in 632.

At 640, once the threshold T2 has been reached, incref deltas 330 are moved from the range structures 420 to an array structure 510. The emptied range structures 420 are then moved to the free-range bin 170, where they are available for allocation for tracking increfs directed to other LIs among the active tablet 152-1.

At 642, node 120 provides additional increfs to LI-1. Such new incref deltas may also be referred to herein as a “third plurality of increfs.” Node 120 performs updates in place for such increfs within the array structure 510. The array structure 510 remains in place until the next tablet switch 154.

As node 120 performs the acts 610 through 652 (shown to the left of FIG. 6), node 120 also performs certain acts shown to the right. For example, at 650 node 120 monitors the fullness of the active tablet 152-1. For example, a fixed amount of memory may be allocated the active tablet 152-1 from the memory pool 150, and node 120 monitors how much of this allocated memory is still free. At some point, the amount of free memory approaches zero, e.g., reaches a low-water mark.

At 660, node 120 detects this full-memory condition, whereupon operation proceeds to 670. Here, node 120 triggers a tablet switch 154. As part of the process of switching the tablets and destaging metadata changes to storage 190, node 120 identifies the hottest LIs, i.e., those which received the greatest number of increfs during the cycle that just ended. For example, node 120 may check the number of deltas statistic 350 for each LI that it encounters when destaging as well as the type of data structure used to track increfs for each LI (e.g., range or array). As destaging progresses, node 120 produces a table 180 of the hottest LIs, such as the top 1,000 LIs. The hot-page table 180 is then leveraged to pre-configure the expected data structure to be used per LI on the next cycle. For example, if a hot LI in the table 180 used range structures 420 at the time of the tablet switch 154, node 120 will initially configure that LI to use range structures 420 at the start of the next cycle. Likewise, if a hot LI in the table 180 used an array structure 510 at the time of the tablet switch 154, node 120 will initially configure that LI to use an array structure 510 at the start of the next cycle. LIs not listed in the hot-page table 180 are configured to initially use record structures 340. This arrangement avoids unnecessary processing involved in transitioning between data-structure types on the next cycle, based on the assumption that an LI that was hot in the previous cycle will also be hot in the current one. Upon the next tablet switch 154, operation returns to 610 and repeats, except that certain acts may be omitted if LI-1 is listed in the hot-page table 180.

In FIG. 7, the method 700 provides a way of managing increfs of virtual-block entries of a metadata page. Method 700 also provides an overview of certain features described above.

At 710, a plurality of increfs 330 is recorded in a plurality of record structures 340. Each of the plurality of record structures 340 is provided for storing one or more increfs 330 of a single respective virtual-block entry, such as LI-1, of a metadata page 140. At least one of the record structures 340 is allocated from a free-record bin 160 in memory.

At 720, in response to an occurrence of a change condition, such as a number of deltas 320 and 330 in a delta list 310 reaching a first threshold (T1), the plurality of increfs 330 is moved from the plurality of record structures 340 to a set of range structures 420. Each of the set of range structures 420 is provided for storing one or more increfs 320 for a respective range of multiple contiguous virtual-block entries of the metadata page 140.

At 730, the plurality of record structures 340 is added to the free-record bin. The record structures 340 are then available to be reused for recording increfs directed to other metadata pages 140.

An improved technique has been described of managing increfs 320. The technique includes initially recording increfs 320 directed to virtual block entries 250 of a metadata page 140 in respective record structures 340. The virtual-block entries 250 are associated with respective data blocks 242 and hold reference counts 280 for those data blocks. At least one of the record structures 340 is allocated from a free-record bin 160. The technique further includes, in response to a change condition, moving the increfs 320 from the record structures 340 to a set of range structures 420, where a range structure 420 covers a contiguous range of multiple virtual-block entries 250 of the metadata page 140, and sending the record structures 340 in the free-record bin 160.

In some examples, the methods 600 and/or 700 may be embodied as a computer program product including one or more non-transient, computer-readable storage media 750, such as a magnetic disk, magnetic tape, compact disk, DVD, optical disk, flash drive, solid state drive, SD (Secure Digital) chip or device, Application Specific Integrated Circuit (ASIC), Field Programmable Gate Array (FPGA), and/or the like. Any number of computer-readable media may be used. The media may be encoded with instructions which, when executed on one or more computers or other processors, perform the process or processes described herein. Such media may be considered articles of manufacture or machines, and may be transportable from one machine to another.

Having described certain embodiments, numerous alternative embodiments or variations can be made. For example, although embodiments have been described that involve one or more data storage systems, other embodiments may involve computers, including those not normally regarded as data storage systems. Such computers may include servers, such as those used in data centers and enterprises, as well as general purpose computers, personal computers, and numerous devices, such as smart phones, tablet computers, personal data assistants, and the like.

Further, although features have been shown and described with reference to particular embodiments hereof, such features may be included and hereby are included in any of the disclosed embodiments and their variants. Thus, it is understood that features disclosed in connection with any embodiment are included in any other embodiment.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Further, although the term “user” as used herein may refer to a human being, the term is also intended to cover non-human entities, such as robots, bots, and other computer-implemented programs and technologies. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

What is claimed is:

1. A method of managing increfs (reference-count increments) of virtual-block entries of a metadata page, comprising:
recording a plurality of increfs in a plurality of record structures, each of the plurality of record structures provided for storing one or more increfs of a single respective virtual-block entry of the metadata page, at least one of the record structures allocated from a free-record bin in memory;
in response to an occurrence of a change condition, moving the plurality of increfs from the plurality of record structures to a set of range structures, each of the set of range structures provided for storing one or more increfs for a respective range of multiple contiguous virtual-block entries of the metadata page; and
adding the plurality of record structures to the free-record bin.

2. The method of claim 1, further comprising, after moving the plurality of increfs from the plurality of record structures to the set of range structures, processing a second plurality of increfs, said processing including updating in place numbers of increfs recorded in the set of range structures to account for the second plurality of increfs.

3. The method of claim 1, wherein recording the plurality of increfs in the plurality of record structures includes arranging the plurality of increfs in a delta list, the delta list including both the plurality of increfs and a plurality of non-incref metadata changes directed to the metadata page, and wherein the occurrence of the change condition is based at least in part on a total number of increfs and non-incref metadata changes in the delta list reaching a threshold number.

4. The method of claim 1, wherein increfs of the virtual-block entries of the metadata page are counted in cycles, and wherein the method further comprises:
during a first cycle, placing an identifier of the metadata page in a table of hot metadata pages responsive to a number of increfs recorded for the metadata page being in a top population compared with numbers of increfs recorded for other metadata pages; and
during a second cycle that immediately follows the first cycle, initially recording increfs directed to the virtual-block entries of the metadata page in range structures rather than record structures responsive to the identifier of the metadata page being found in the table of hot metadata pages.

5. The method of claim 1, wherein moving the plurality of increfs from the plurality of record structures to the set of range structures includes obtaining at least one of the set of range structures from a free-range bin in memory.

6. The method of claim 5, wherein the set of range structures includes a plurality of range structures, and wherein the method further comprises:
in response to an occurrence of a second change condition, moving the plurality of increfs from the plurality of range structures to an array structure provided for storing increfs for all virtual-block entries of the metadata page; and
sending the plurality of range structures to the free-range bin.

7. The method of claim 6, further comprising, after moving the plurality of increfs from the plurality of range structures to the array structure, processing a third plurality of increfs, said processing of the third plurality of increfs including updating in place numbers of increfs recorded in the array structure to account for the third plurality of increfs.

8. The method of claim 6, further comprising arranging the plurality of range structures in a range list, wherein the occurrence of the second change condition is based at least in part on a total number of ranges in the range list reaching a second threshold number.

9. The method of claim 8, wherein increfs of the virtual-block entries of the metadata page are counted in cycles, and wherein the method further comprises:
during a first cycle, placing an identifier of the metadata page in a table of hot metadata pages responsive to a number of increfs recorded for the metadata page being in a top population compared with numbers of increfs recorded for other metadata pages; and
during a second cycle that immediately follows the first cycle, initially recording increfs directed to the virtual-block entries of the metadata page in an array structure rather than record structures or range structures responsive to the identifier of the metadata page being found in the table of hot metadata pages.

10. A computerized apparatus, comprising control circuitry that includes a set of processors coupled to memory, the control circuitry constructed and arranged to:
record a plurality of increfs in a plurality of record structures, each of the plurality of record structures provided for storing one or more increfs of a single respective virtual-block entry of a metadata page, at least one of the record structures allocated from a free-record bin in memory;
in response to an occurrence of a change condition, move the plurality of increfs from the plurality of record structures to a set of range structures, each of the set of range structures provided for storing one or more increfs for a respective range of multiple contiguous virtual-block entries of the metadata page; and
add the plurality of record structures to the free-record bin.

11. The computerized apparatus of claim 10, wherein the control circuitry constructed and arranged to move the plurality of increfs from the plurality of record structures to the set of range structures is further constructed and arranged to obtain at least one of the set of range structures from a free-range bin in memory.

12. A computer program product including a set of non-transitory, computer-readable media having instructions which, when executed by control circuitry of a computerized apparatus, cause the computerized apparatus to perform a method of managing increfs (reference-count increments) of virtual-block entries of a metadata page, the method comprising:
recording a plurality of increfs in a plurality of record structures, each of the plurality of record structures provided for storing one or more increfs of a single respective virtual-block entry of the metadata page, at least one of the record structures allocated from a free-record bin in memory;
in response to an occurrence of a change condition, moving the plurality of increfs from the plurality of record structures to a set of range structures, each of the set of range structures provided for storing one or more increfs for a respective range of multiple contiguous virtual-block entries of the metadata page; and
adding the plurality of record structures to the free-record bin.

13. The computer program product of claim 12, wherein the method further comprises, after moving the plurality of increfs from the plurality of record structures to the set of range structures, processing a second plurality of increfs, said processing including updating in place numbers of increfs recorded in the set of range structures to account for the second plurality of increfs.

14. The computer program product of claim 12, wherein recording the plurality of increfs in the plurality of record structures includes arranging the plurality of increfs in a delta list, the delta list including both the plurality of increfs and a plurality of non-incref metadata changes directed to the metadata page, and wherein the occurrence of the change condition is based at least in part on a total number of increfs and non-incref metadata changes in the delta list reaching a threshold number.

15. The computer program product of claim 12, wherein increfs of the virtual-block entries of the metadata page are counted in cycles, and wherein the method further comprises:
during a first cycle, placing an identifier of the metadata page in a table of hot metadata pages responsive to a number of increfs recorded for the metadata page being in a top population compared with numbers of increfs recorded for other metadata pages; and
during a second cycle that immediately follows the first cycle, initially recording increfs directed to the virtual-block entries of the metadata page in range structures rather than record structures responsive to the identifier of the metadata page being found in the table of hot metadata pages.

16. The computer program product of claim 12, wherein moving the plurality of increfs from the plurality of record structures to the set of range structures includes obtaining at least one of the set of range structures from a free-range bin in memory.

17. The computer program product of claim 16, wherein the set of range structures includes a plurality of range structures, and wherein the method further comprises:
in response to an occurrence of a second change condition, moving the plurality of increfs from the plurality of range structures to an array structure provided for storing increfs for all virtual-block entries of the metadata page; and
sending the plurality of range structures to the free-range bin.

18. The computer program product of claim 17, wherein the method further comprises, after moving the plurality of increfs from the plurality of range structures to the array structure, processing a third plurality of increfs, said processing of the third plurality of increfs including updating in place numbers of increfs recorded in the array structure to account for the third plurality of increfs.

19. The computer program product of claim 17, wherein the method further comprises arranging the plurality of range structures in a range list, wherein the occurrence of the second change condition is based at least in part on a total number of ranges in the range list reaching a second threshold number.

20. The computer program product of claim 19, wherein increfs of the virtual-block entries of the metadata page are counted in cycles, and wherein the method further comprises:
during a first cycle, placing an identifier of the metadata page in a table of hot metadata pages responsive to a number of increfs recorded for the metadata page being in a top population compared with numbers of increfs recorded for other metadata pages; and
during a second cycle that immediately follows the first cycle, initially recording increfs directed to the virtual-block entries of the metadata page in an array structure rather than record structures or range structures responsive to the identifier of the metadata page being found in the table of hot metadata pages.
